(19) United States
(12) Patent Application Publication
(10) Pub. No.: US 2014/0126763 A1
(43) Pub. Date: May 8, 2014

(54) EAR WARMER AND HEADPHONE DEVICE

(71) Applicant: DAVID & YOUNG GROUP CORP., Secaucus, NJ (US)

(72) Inventor: John Yoo, Secaucus, NJ (US)

(73) Assignee: David & Young Group Corp., Secaucus, NJ (US)

(21) Appl. No.: 13/667,161

(22) Filed: Nov. 2, 2012

(51) Int. Cl. H04R 1/10

(52) U.S. Cl. 381/371

(57) ABSTRACT

An ear muff and headphone device having a warmth optimizing mode and a sound optimizing mode includes an earmuff body including at least one coupling element disposed along at least a portion of a perimeter of said earmuff body. A cushioning member is mounted on an interior side of the earmuff body, said cushioning member defining a rim area having a perimeter. At least one insulator member having at least one coupling element able to be releasably attached to the at least one coupling element of the earmuff body is provided.

### TECHNICAL FIELD

The present disclosure generally relates to ear muffs, and more particularly to a combination ear muff and headphone device which can provide cold weather protection of the ears as well as improved acoustic sound functionality.

### BACKGROUND

Earmuffs and ear warmers are used for protecting ears from cold weather and typically comprise two insulated members or muffs for covering the ears which are joined by a curved band. The muffs can be comprised of insulating material, such as various types of cloth, synthetic or natural fur, and may or may not include padding or filler materials. Muffs can be in any size, shape and configuration for fitting over and covering the ears. The band can be adjustable and is designed to fit over the user's head to maintain the muffs in contact with the ears of the user.

Similar in appearance to ear warming devices, devices such as headphones, earphones and headsets are used to position speakers over the ears in order to project sound emitted from a receiver or media player device directly to the ears of the user, to enable the user to listen to the sound privately. The speakers are typically held together with a flexible, curved band which extends over the head and holds the speakers adjacent to each ear, much in the same way ear muffs are held over the ears.

Earmuffs and headphones are typically not used together, in particular due to their conflicting purposes. Some attempts have been made in the past to integrate the objective of insulating the ear while wearing headphones, but have inherent disadvantages and limitations, such as compromising warmth, sound quality and/or ease of use.

Accordingly, there remains a need for a device which can incorporate an ear warmer with headphone functionality while maintaining and improving protection from the elements, optimizing acoustic functionality and facilitating ease of use.

### SUMMARY

Accordingly, an ear warmer and headphone device and method for use are provided.

In one embodiment, an ear muff and headphone device is provided comprising a first earmuff element and a second earmuff element, each including a coupling element; a connector portion for connecting the first earmuff element to the second earmuff element and for positioning the device substantially over a user's ears; and at least one insulator member having a coupling element capable of being releasably attached to at least one of the coupling elements of the first earmuff element and the second earmuff element.

In another embodiment, an ear muff and headphone device is provided comprising an earmuff body including at least one coupling element disposed along at least a portion of a perimeter of said earmuff body; and at least one insulator member having at least one coupling element able to be releasably attached to the at least one coupling element of the earmuff body.

In yet another embodiment, an ear muff and headphone device having a warmth optimizing mode and a sound optimizing mode is provided comprising an earmuff body including at least one coupling element disposed along at least a portion of a perimeter of said earmuff body; a cushioning member mounted on an interior side of the earmuff body, said cushioning member defining a rim area having a perimeter; and at least one insulator member having at least one coupling element able to be releasably attached to the at least one coupling element of the earmuff body, wherein the insulator member comprises a cover having a disc-shape and a raised edge, the at least one coupling element of the insulator member being disposed along at least a portion of a perimeter of the raised edge.

These and other aspects, features and advantages of the present disclosure will be described or become apparent from the following detailed description, which is to be read in connection with the accompanying drawings.

### BRIEF DESCRIPTION OF THE DRAWINGS

The present disclosure will become more readily apparent from the specific description accompanied by the following drawings, in which:

FIG. 1 is a front view of one embodiment of an ear warmer and headphone device in a listening mode in accordance with the principles of the present disclosure;

FIG. 2 is a front perspective view of the ear warmer and headphone device of FIG. 1 in accordance with the principles of the present disclosure;

FIG. 3 is a bottom view of a removable insulator of the ear warmer and headphone device;

FIG. 4 is a front perspective view of an ear warmer and headphone device with one insulator attached in accordance with the principles of the present disclosure;

FIG. 5 is a front perspective view of an ear warmer and headphone device in an ear warming mode in accordance with the principles of the present disclosure;

FIG. 6 is a cross-sectional view taken along line 6-6 of FIG. 3;

FIG. 7 is a cross-sectional view taken along line 7-7 of FIG. 1;

FIG. 8 is a cross-sectional view taken along line 8-8 of FIG. 4;

FIG. 9 is a cross-sectional view of an earmuff according to an alternate embodiment; and

FIGS. 10-13 are front views of ear warmer and headphone devices according to various embodiments of the present disclosure.

Like reference numerals indicate similar parts throughout the figures.

It is to be understood that the figures are not drawn to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

### DETAILED DESCRIPTION OF PREFERRED EMBODIMENTS

The exemplary embodiments of the ear warmer and headphone device and related methods of use disclosed are discussed in terms of wearable accessories, to provide optimal warmth to the user's ears in an ear warming mode as well as optimal acoustic functionality during a listening mode.

It is envisioned that the ear warmer and headphone device and method may be employed with additional devices, features and/or methods for providing additional functionality such as, volume control, sound quality and effects, and the like.

The present disclosure may be understood more readily by reference to the following detailed description of the disclosure taken in connection with the accompanying drawing figures, which form a part of this disclosure. It is to be understood that this disclosure is not limited to the specific devices, methods or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

The following discussion includes a description of an ear warmer and headphone device and related methods of using same in accordance with the principles of the present disclosure. Alternate embodiments are also disclosed. Reference will now be made in detail to certain exemplary embodiments of the present disclosure, examples of which are illustrated in the accompanying figures. While the application will be described in conjunction with the illustrated embodiments, it will be understood that they are not intended to limit the application to those embodiments. On the contrary, the application is intended to cover all alternatives, modifications, and equivalents, which may be included within the application as defined by the appended claims.

The headings below are not meant to limit the disclosure in any way; embodiments under any one heading may be used in conjunction with embodiments under any other heading.

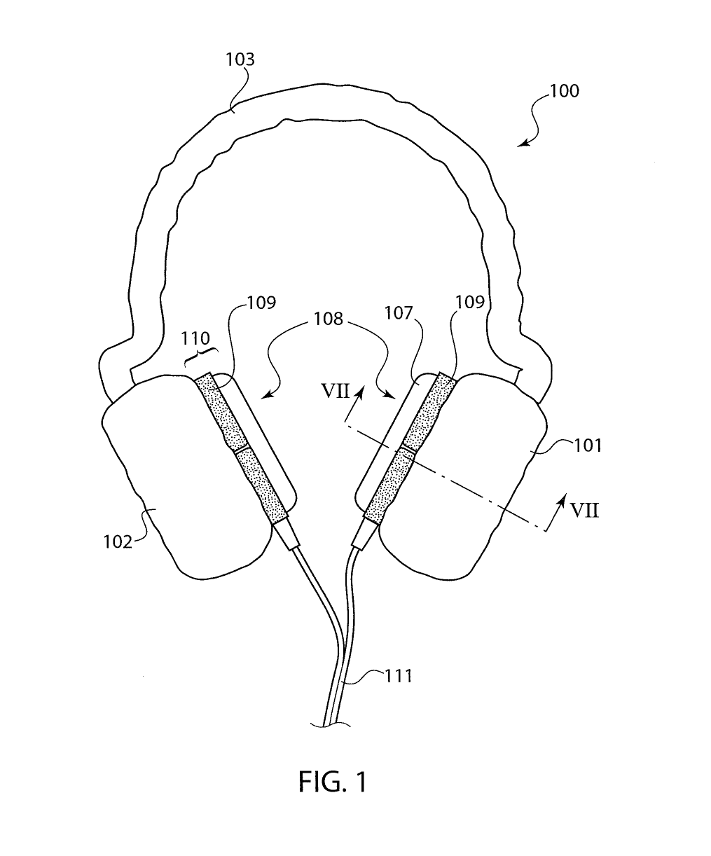

Turning now to FIGS. 1-9, there are illustrated components of an ear warmer and headphone device in accordance with principles of the present disclosure.

The components of an ear warmer and headphone device 100 can be fabricated from any substantially rigid and/or flexible materials, including metals, synthetic polymers, plastics, rubber, carbon fiber, wood and/or their composites and combinations thereof, depending on the properties desired. Various components of the ear warmer and headphone device 100 may have material composites, including the above materials, to achieve various desired characteristics such as strength, rigidity, resiliency, elasticity and/or durability. The components of the ear warmer and headphone device 100 may each be monolithically formed and integrally connected.

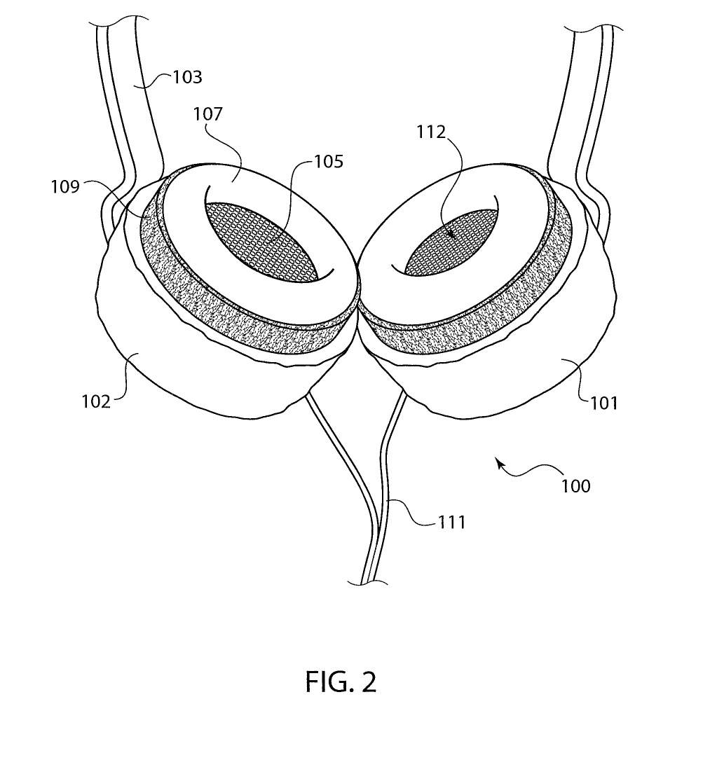

FIG. 1 illustrates a front view of one embodiment of an ear warmer and headphone device 100 in an optimized listening mode in accordance with the principles of the present disclosure. FIG. 2 is a front perspective view of the ear warmer and headphone device of FIG. 1.

In one embodiment, the ear warmer and headphone device 100 comprises a first earmuff element 101 and a second earmuff element 102, which are each connected to each with a connector 103 for securing the earmuffs 101, 102 over a body region, such as a user's head. The first and second earmuff elements 101, 102 may be any shape, such as, for example, circular, oval, oblong, triangular, rectangular, square, polygonal, irregular, uniform, non-uniform, variable and/or tapered, and may be any thickness, length or width and/or may be further adapted to conform to a particular body area or shape, such as a user's external ear area.

Each of the first and second earmuff elements 101, 102 may include a cushioning member 107 mounted on an interior side 108 of each earmuff element 101, 102, for example, as depicted in FIGS. 1 and 2. The cushioning member 107 may be comprised of any material having e.g., cushioning and/or resilient properties, such as foam, padding, rubber and the like for maximizing comfort for the user, and may be in any shape, thickness, length or width. In one embodiment, the cushioning member 107 may include a recess or void 112 located, e.g., in a substantially central area of the member 107. A speaker 105 designed to fit at least within the recessed area may be mounted within the void 112. For example, the cushioning member 107 may comprise a donut-shape with a hole 112 at which a speaker 105 is oriented. Speaker wires 111 may be provided connected to each of the speakers 105 for functional attachment to an electronic device, such as a portable music player.

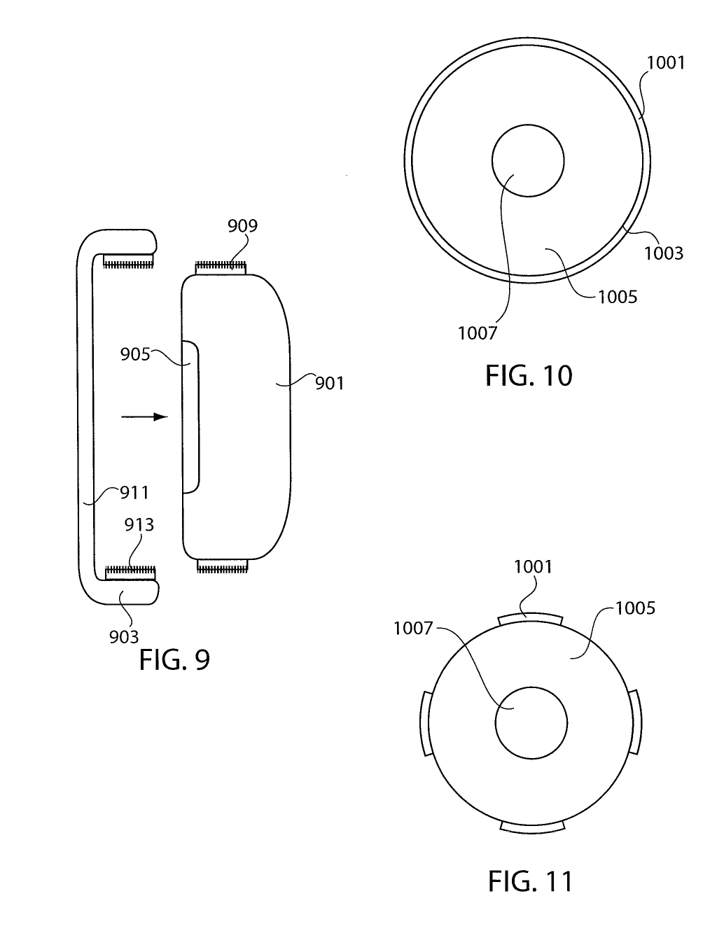

Each of the first and second earmuff elements 101, 102 may include a rim area 110 protruding from the interior side 108. The rim 110 may be comprised of any shape, thickness or width and may be defined at least in part by the protruding thickness of the cushioning member 107. The rim 110 includes an exterior surface, which from, e.g., a front view (as shown in FIGS. 10-13) defines a perimeter of the rim 110. A width as well as a perimeter or circumference of the rim 110 may comprise any distance or dimension. At least one coupling element 109 may be affixed to at least a portion of, or to the entire perimeter/circumference and/or surface area of the rim 110.

For example, the coupling element 109 may comprise a substantially continuous strip of hook and loop fasteners affixed around the circumference of the rim 110. Alternate coupling element may be contemplated, including buttons, button holes, hooks, latches, intermittent or staggered portions/strips of hook and loop fasteners, additional layers of folded material which may include hook and loop fastener portions, and any other coupling element and any combination thereof. The type, amount, configuration, orientation and/or placement of the coupling element 109 is a matter of discretion and may be varied as necessary for the desired amount of attachment strength of a removable insulator (described further below). Moreover, it is envisioned that affixing of such coupling element 109 to the rim 110 may be provided through various ways, such as by adhesives, threading, stapling, and the like. It is further contemplated that the coupling element 109 may be integrally formed with the rim 110, either entirely or in part.

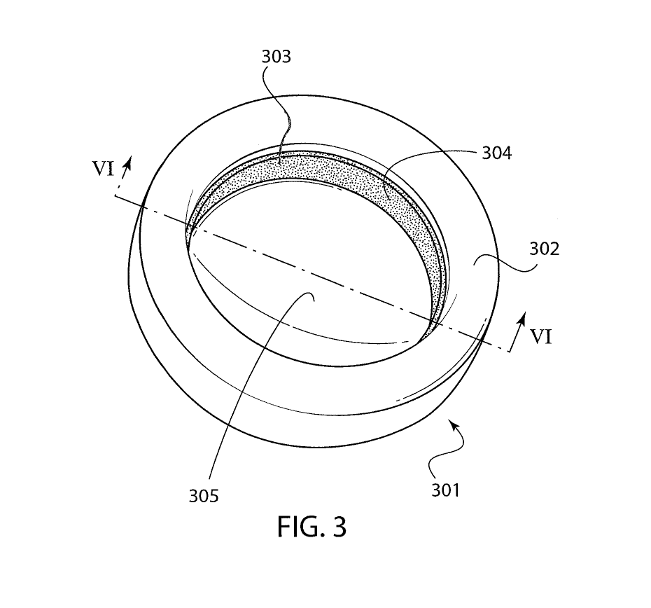

FIG. 3 is a bottom view of a removable insulator 301 configured for releasable attachment to the ear warmer and headphone device 100. The insulator 301 may comprise a cover 302 constructed of any material to suit user preferences, and in particular, preferably has insulating properties for retaining warmth and is soft for comfortable wear next to the skin. Suitable materials may include, e.g., natural or synthetic furs and fibers, any type of woven or knit cloth, felt, velvet, and composites and/or blends thereof. Various shapes, thicknesses and sizes of the insulator 301 may be contemplated, e.g., circular, oval, polygonal, etc. In an exemplary embodiment, the insulator 301 may be configured and sized to provide adequate coverage for a user's external ear area.

In one embodiment as shown in FIG. 3, the insulator 301 may comprise a cover 302 having a disc-like or biconcave shape including a recessed or concave interior 305. In this embodiment, a raised edge 303 is provided around a perimeter of the concave interior 305. The raised edges 303 may be formed by overlapping the edges of the cover 302 to form two layers (as shown in FIGS. 3 and 8) or may comprise a single-layer, or any combination thereof. Various thicknesses and dimensions of the raised edge 303 may be contemplated.

At least a portion of, or alternately, the entire perimeter of the surface area of the raised edge 303 may include at least one coupling element 304 affixed thereon. The coupling element 304 may comprise any fastening means able to releasably engage with the coupling element 109 of the earmuffs 101. For example, where coupling element 109 comprises a hook and loop fastener, the coupling element 304 may comprise a counterpart hook and loop fastener which can engage with the coupling element 109. Alternate types and configurations of coupling elements and other attachment means may be contemplated. The coupling elements 109, 304 are preferably sized, shaped and/or oriented to achieve effective engagement between the earmuff 101, 102 and the insulator 301 when the insulator 301 is affixed accordingly.

In an exemplary embodiment, the coupling element 304 may be provided as a continuous strip of a fabric hook and loop fastener as shown in FIG. 3. Alternate embodiments may be contemplated, including a coupling element 304 which comprises portions of hook and loop fasteners distributed in staggered arrangements or disposed at predetermined intervals along the raised edge 303, buttons or button holes, hooks, latches, and the like. The coupling element 304 of the insulator 301 may be arranged in any formation or configuration to enable engagement with the coupling element 109.

The thickness or depth 306 of the raised edge 303 of the insulator 301 may be varied according to, e.g., a thickness of the cushioning member 107 and/or the rim 109. In one embodiment, the raised edge 303 is of a sufficient depth to overlap and cover the cushioning member 107 (e.g., as shown in FIG. 8). In some embodiments the thickness of the raised edge 303 may comprise a range of for example, about 0.5 inch to about 2.0 inches.

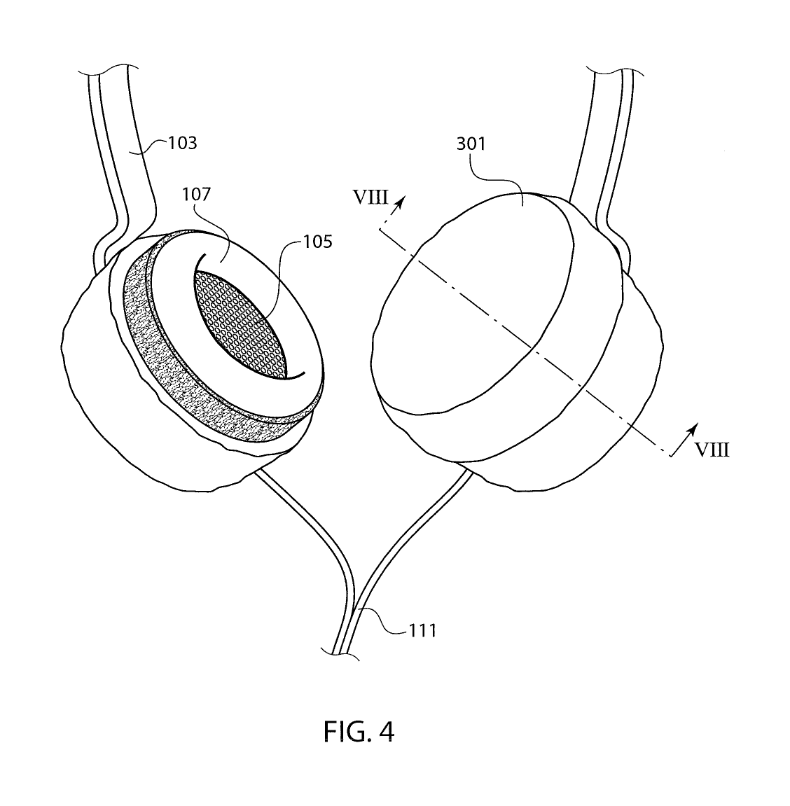

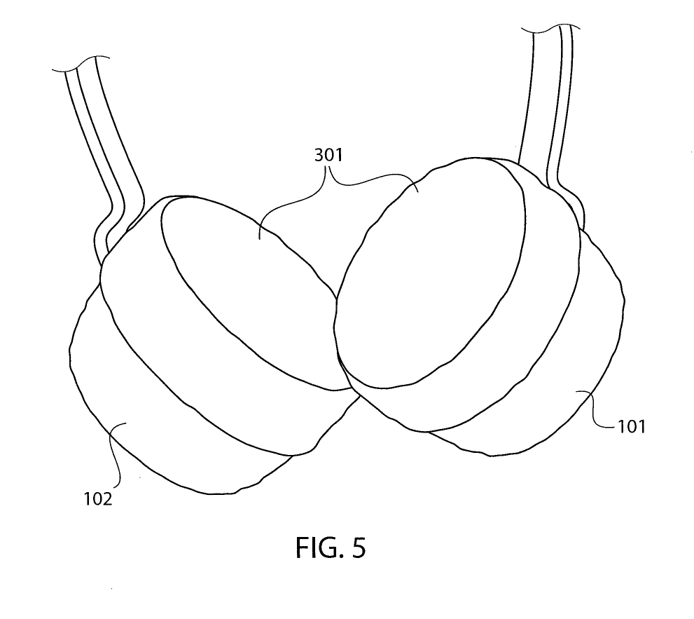

FIG. 4 is a front perspective view of an ear warmer and headphone device with one insulator 301 attached in accordance with the principles of the present disclosure. FIG. 5 is a front perspective view of an ear warmer and headphone device in an optimized ear warming mode in which insulators 301 are attached to each of the earmuffs 101, 102 in accordance with the principles of the present disclosure. As shown, one or both insulators 301 may be affixed to or removed from either earmuff 101, 102 as desired, thus advantageously providing flexibility for the user in modifying the earmuff and headphone device to either optimize the sound quality from the speakers 105 (i.e., to provide an optimized listening mode, as shown in FIG. 1) or to optimize warmth for one or both ears (i.e., to provide an optimized ear warming mode, as shown in FIGS. 4 and 5).

Namely, in the ‘optimized ear warming mode’, the insulator 301 is caused to contact the user's ear directly and e.g., acts as an insulating layer to help trap and hold warm air between the speaker 105 and the user's ear.

In the ‘optimized listening mode’, the user's ear is enabled to be in direct contact (or substantially direct contact) with the surface of the speaker 105 to provided unimpeded sound transmission.

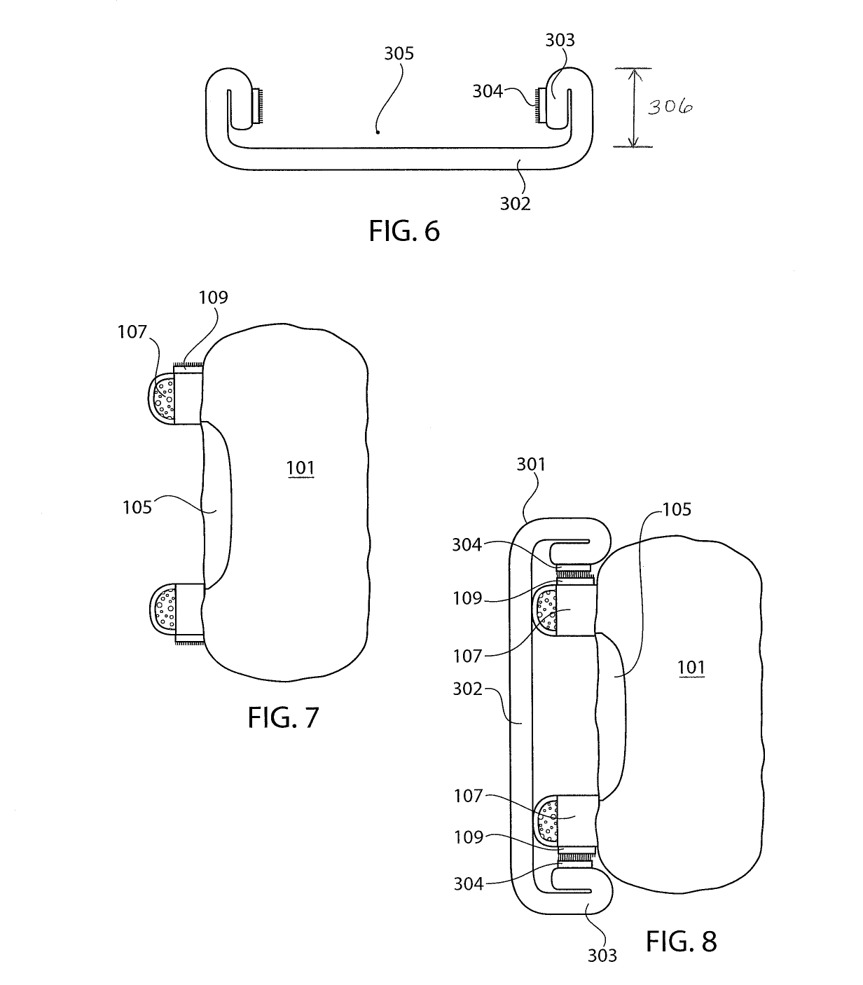

FIG. 6 is a cross-sectional view of the insulator 301 taken along line 6-6 of FIG. 3, showing the biconcave shape of the insulator 301 including the recess 305 and depicting the raised edge 303.

FIG. 7 is a cross-sectional view taken along line 7-7 of FIG. 1, showing the earmuff 101 in an optimized listening mode (i.e., with no insulator 301 attached). In this mode, there is no barrier between the user's ear and the speaker 105, thus enabling the sound to be transmitted optimally into the ear.

FIG. 8 is a cross-sectional view taken along line 8-8 of FIG. 4, showing the earmuff 101 in an optimized ear warming mode, depicting the insulator 301 affixed to the earmuff 101 via connection of the respective coupling elements 109, 304. When the insulator 301 is attached as such, the cover 302 contacts the ear and thus an insulating layer is accordingly provided between the user's ear and the cushioning member 107 and speaker 105, optimizing warmth and protection from the elements for the ear.

Alternate embodiments of the earmuff and headphone device may be contemplated, such as that shown in FIG. 9, which illustrates a cross-sectional view of an earmuff body 901 which is devoid of a cushioning member and instead includes at least one coupling elements 909 disposed directly on each earmuff body 901. An exemplary view of such embodiment as viewed from the user's ear towards the earmuff is depicted in FIGS. 10 and 11 below. For example, the coupling elements 909 may be disposed along at least a portion of, or along an entire length of, a perimeter or circumference of the earmuff body 901 (e.g., when the earmuff body is viewed from the user's ear towards the direction of the earmuff body). For example, in the instance where the earmuff body 901 is circular in shape, the circumference may comprise the exterior surface of a circular earmuff when viewed from the front or back.

In a warmth-optimizing mode, an insulator 911 (here depicted in an exemplary embodiment in which a raised edge 903 comprises a single layer) may be attached directly to the body of the muff 901 via its coupling elements 913 engaging with the coupling elements 909 and the insulator 911 directly contacts the ear when the device is worn. In a sound optimizing mode, the insulator is removed from the muff 901, and the user's external ear contacts the speaker 905 directly. It is noted that the configuration described with reference to FIG. 9 may apply to a single or double earmuff embodiment.

In operation, it is envisioned that each insulator 301 may be easily and quickly manually removed and attached to one or both earmuffs 101, 102 as desired by a user when either sound quality or warmth is desired to be maximized.

Single earmuff embodiments may be contemplated, for example, in which a single earmuff element is provided which may be attached, e.g., to one ear via various mechanisms such as, e.g., a hook element placed over the back of the ear. A single earmuff may include any and all of the features described herein for enabling releasable engagement with an insulator member to provide sound-optimizing or warmth-optimizing modes as described herein.

FIGS. 10-13 each comprise a view of an earmuff body looking towards the earmuff from the ear of the user according to various embodiments of the present disclosure.

For example, FIG. 10 depicts an earmuff body as described with reference to FIG. 9, showing a continuous length of a coupling element 1001 disposed along a perimeter 1003 of a muff body 1005 which includes a speaker 1007. FIG. 11 depicts an earmuff body according to FIG. 10, but having coupling elements 1001 disposed in a staggered arrangement around the perimeter 1003 of the muff body 1005.

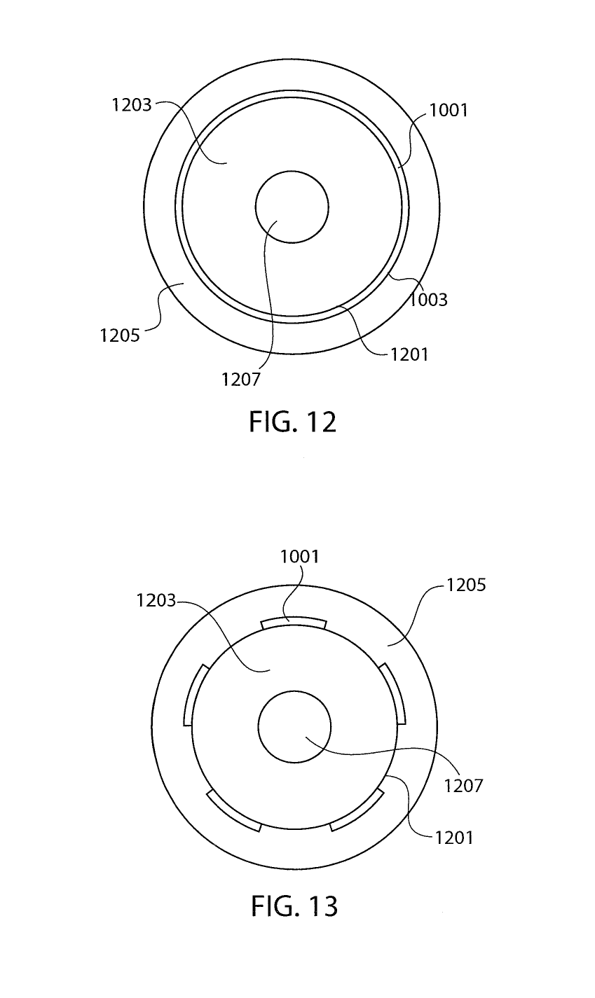

FIG. 12 depicts an earmuff body as described with reference to the embodiment described in FIGS. 1 and 2, showing a continuous length of a coupling element 1001 disposed along a perimeter 1201 of a cushioning member 1203 attached to an interior side of a muff body 1205 which includes a speaker 1207. FIG. 13 depicts an earmuff body according to FIG. 12, but having coupling elements 1001 disposed in a staggered arrangement around the perimeter 1201 of the cushioning member 1203.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. An ear muff and headphone device comprising:
a first earmuff element and a second earmuff element, each including a coupling element;
a connector portion for connecting the first earmuff element to the second earmuff element and for positioning the device substantially over a user's ears; and
at least one insulator member having a coupling element capable of being releasably attached to at least one of the coupling elements of the first earmuff element and the second earmuff element.

2. The device of claim 1, wherein the coupling element of each of the first and second earmuff elements is disposed along at least a portion of a perimeter of said first and second earmuff elements.

3. The device of claim 1, wherein the insulator member comprises a cover having a disc-shape and a raised edge.

4. The device of claim 3, wherein the coupling element of the insulator member is disposed along at least a portion of a perimeter of the raised edge.

5. The device of claim 3, wherein the raised edge comprises a thickness of about 0.5 inch to about 2.0 inches.

6. The device of claim 1, wherein at least one of the first and second earmuff elements includes a speaker.

7. The device of claim 1, wherein at least one of the first and second earmuff elements further includes a cushioning member mounted on an interior side, said cushioning member defining a rim area having a perimeter.

8. The device of claim 7, wherein the coupling element of each of the first and second earmuff elements is disposed along at least a portion of the perimeter of the rim area.

9. The device of claim 7, wherein the cushioning member comprises a donut shape.

10. The device of claim 9, further comprising a speaker oriented proximate to the hole of the cushioning member.

11. The device of claim 1, wherein the coupling element comprises at least one of hook and loop fasteners, buttons, button holes, hooks and latches.

12. The device of claim 1, wherein the insulator is attached to at least one of the first and second earmuff elements in a warmth optimizing mode.

13. The device of claim 1, wherein the insulator is detached from the at least one of the first and second earmuff elements in a sound optimizing mode.

14. An ear muff and headphone device comprising:
an earmuff body including at least one coupling element disposed along at least a portion of a perimeter of said earmuff body; and
at least one insulator member having at least one coupling element able to be releasably attached to the at least one coupling element of the earmuff body.

15. The device of claim 14, wherein the insulator member comprises a cover having a disc-shape and a raised edge.

16. The device of claim 15, wherein the at least one coupling element of the insulator member is disposed along at least a portion of a perimeter of the raised edge.

17. The device of claim 14, wherein the earmuff body further includes a cushioning member mounted on an interior side, said cushioning member defining a rim area having a perimeter.

18. The device of claim 17, wherein the coupling element of the earmuff body is disposed along at least a portion of the perimeter of the rim area.

19. The device of claim 14, wherein the insulator is attached to the earmuff body in a warmth optimizing mode, and is detached from the earmuff body in a sound optimizing mode.

20. An ear muff and headphone device having a warmth optimizing mode and a sound optimizing mode comprising:
an earmuff body including at least one coupling element disposed along at least a portion of a perimeter of said earmuff body;
a cushioning member mounted on an interior side of the earmuff body, said cushioning member defining a rim area having a perimeter; and
at least one insulator member having at least one coupling element able to be releasably attached to the at least one coupling element of the earmuff body, wherein the insulator member comprises a cover having a disc-shape and a raised edge, the at least one coupling element of the insulator member being disposed along at least a portion of a perimeter of the raised edge.
